(19) United States
(12) Patent Application Publication
(10) Pub. No.: US 2008/0005286 A1
(43) Pub. Date: Jan. 3, 2008

(54) Step-wise command line interface for configuring network devices

(76) Inventors: Michael E. Short, Roseville, CA (US); Daniel E. Ford, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/477,862

(22) Filed: Jun. 30, 2006

(51) Int. Cl. G06F 15/177

(52) U.S. Cl. 709/220

(57) ABSTRACT

Apparatus, methods, processors and computer readable media for providing a command line interface for applying commands to network devices over a network. Embodiments include transmitting a command to a network device and then waiting for the network device to complete execution of the transmitted command before transmitting another command to the network device. In some embodiments, the command line interface will perform a consistency check of the network and/or the network device after the network device has completed execution of the transmitted command.

### BACKGROUND

Managing network devices such as routers and bridges is a complicated and important task. Network devices often must be reconfigured to accommodate ever-changing circumstances on the network. Many of the graphical-user interfaces (GUIs) of current network management software allow for high-level control and configuration of network devices. The GUIs sequentially execute commands without stopping and without providing an indication of errors encountered.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high-level block diagram of a system according to an embodiment;

FIG. 2 is a high-level diagram of a user interface according to an embodiment;

FIG. 3 is a message flow diagram of operation according to an embodiment; and

FIG. 4 is a flowchart of operation according to an embodiment.

### DETAILED DESCRIPTION

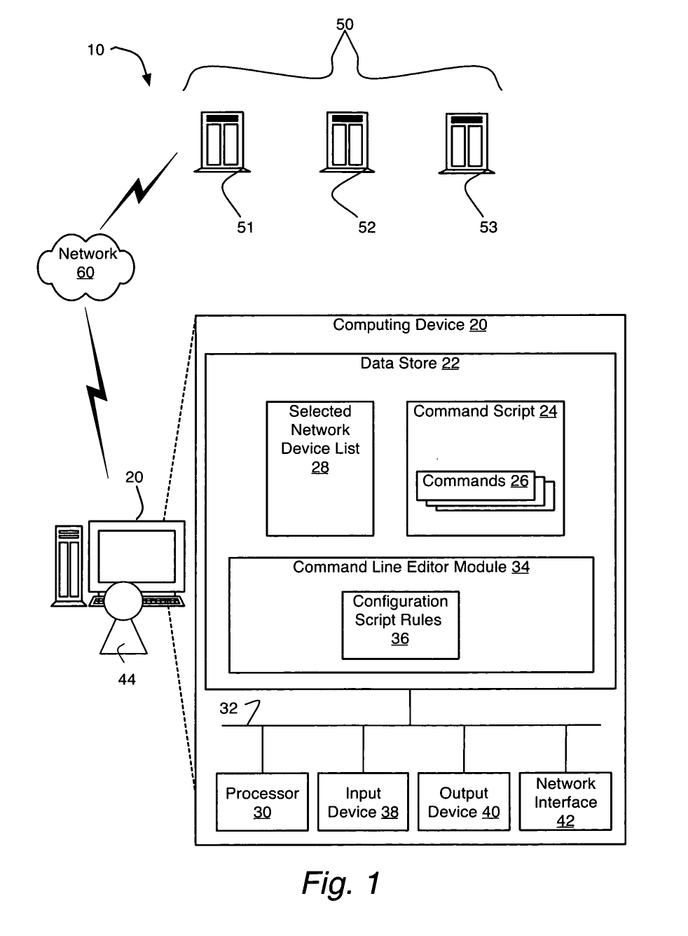

FIG. 1 depicts a high-level block diagram of a system architecture 10 for providing a step-wise command line interface for configuring network devices such as routers, bridges, etc. System architecture 10 comprises a computing device 20 communicatively coupled with three network devices 50, individually referenced by reference numerals 51-53. Computing device 20 communicates configuration command(s) according to a command script 24 to, and receives response(s) from, each of network devices 50. A user 44 of computing device 20 causes the computing device to transmit commands according to command script 24 by manipulation of computing device 20, e.g., manipulation of an input device 38. Computing device 20 transmits a command of command script 24 to network device 51 and waits for a response from the network device. In at least one embodiment, computing device 20 proceeds to transmit commands from command script 24 to network device 51 in a step-wise fashion based on commands received from user 44. In at least one further embodiment, user 44 commands computing device 20 to transmit commands according to command script 24 to the remaining network devices 51, 52.

Computing device 20 is illustrated as a personal computer; however, in at least one embodiment, the computing device may be a mini computer, mainframe computer, a hand-held computer, a laptop computer, a desktop computer, a wireless computer, or any computing device either special purpose or general purpose capable of providing the services necessary to support command line editor module 34.

Computing device 20 comprises a processor 30, a data store 22, an input device 38, an output device 40, and a network interface 42 each communicatively coupled to a bus 32. Network interface 42 communicatively couples computing device 20 to network devices 50 via a network 60.

Input device 38 transmits user-supplied commands and information to computing device 20. For example, input device 38 may include a mechanism such as a keyboard, a touch-screen display, a mouse, and a voice recognition system, etc. In at least one embodiment, input device 38 is wirelessly connected with computing device 20.

Output device 40 is a display for displaying information from processor 30 to user 44. In other embodiments, output device 40 may comprise an audio speaker, a haptic feedback mechanism, or any device capable of communicating information to user 44. In at least one embodiment, output device 40 is wirelessly connected with computing device 20.

Computing device 24 further comprises a network interface 42 coupled to bus 32 for one-way and two-way network communication. Network interface 42 sends and receives electrical, electromagnetic or optical signals which carry digital data streams representing various types of information. Network interface 42 may be an integrated services digital network (ISDN) card, a digital subscriber line (DSL) card, a modem to provide a data communication connection to a corresponding type of telephone line, or as another example, network interface 42 may be a local area network (LAN) card to provide a data communication connection to a compatible LAN. Network interface 42 may also implement wireless links.

Data store 22, such as a magnetic-based memory, an electronic-based memory, or an optical-based memory, is provided and coupled to bus 32 for storing data and instructions for computing device 24. In at least one embodiment, data store 22 stores a command script 24, and a network device list 28 and instructions comprising a command line editor module 34. Command line editor module 34 comprises configuration script rules 36. In at least one embodiment, configuration script rules 36 reside outside, and area accessible by, command line editor module 34 in data store 22.

Network 60 comprises a communication network operable for enabling communication between computing device 20 and network devices 50. Network 60 may be a wired or wireless network, e.g., a fiber-optic network, a copper-based wire network, a cellular telephone network, a satellite telephone network, an analog network, a digital network, etc. The protocols used on network 60 are protocols enabling communication between computing device 20 and network devices 50, e.g., Ethernet, token ring, switched network, etc.

Network devices 50 may be any type of network device, such as a router, a bridge, or any type of device that is adapted to perform a service on network 60, which is configurable remote from the device. That is, each of network devices 50 may be configured from another device connected via network 60.

Command line editor module 34 comprises instructions executable by computing device 20, i.e., processor 30. Command line editor module 34 is initiated by a user 44 or by another set of executable instructions executed either remotely from computing device 20 or locally to the computing device. In at least one embodiment, command line editor module 34 may be stored on another computing device and/or data store and transferred to computing device 20 or may be executed on another computing device and communicate with the computing device.

Command line editor module 34 is adapted to communicate over network 60 to network devices 50 and to provide information to a user 44 by means of an output device 40 and to receive command and information input from the user by means of an input device 38. In at least one embodiment, command line editor module 34 communicates directly with one of network devices 50 if the computing device on which the command line editor module is located is the network device.

Command line editor module 34 transmits commands 26 of a command script 24 to a selected one of network devices 50 in a step-wise fashion, i.e., one command is transmitted at a time to the selected network device. In at least one embodiment, command line editor module 34 transmits a command 26 to the selected network device 50 and waits for receipt of a response from the selected network device. In at least one further embodiment, command line editor module 34 awaits receipt of a response from the selected network device 50 which is indicative of completion of the transmitted command. A response received by command line editor module 34 that the network device 50 has completed executing the transmitted command 26 is a completion response received from the network device. Responsive to receipt of the completion response from the network device 50, computing device 20 displays a message indicative of the completion response to user 44, e.g., by causing output device 40 to display a message to the user. In at least one embodiment, processor 30 causes output device 40 to display the completion response as received. In at least one other embodiment, processor 30 causes output device 40 to display a portion of the completion response.

In at least one embodiment, command line editor module 34 displays the completion response received from network device 50 using text, graphics, or a combination thereof. In at least some embodiments, the completion response information may be conveyed using other modules either remotely or locally located. For example, command line editor module 34 may use a network status module comprising a complex graphical user interface to display the results of executing a command 26 on a network device 50.

In at least one embodiment, command line editor module 34 then waits for user 44 to command the command line editor module to transmit the next instruction to the command line editor module 34. If the completion response displayed to user 44 indicates a successful completion, the user commands command line editor module 34 to continue to a next sequential command 26 in command script 24. In at least one embodiment, user 44 may instruct command line editor module 34 to continue sending the remaining commands 26 in the command script 24 in sequential order to the network device 50 without waiting for a completion response from the network device, i.e., commands are sent in a continuous fashion. User 44 may also instruct the command line editor module 34 to terminate execution.

In at least one embodiment, command line editor module 34 determines that the selected network device 50 has completed or will not complete execution of the transmitted command 26. Command line editor module 34 may comprise setting a timer value to a predetermined time setting and determining that a network device 50 has either completed execution of a command 26 or will not execute the command based on the expiration of the timer. In another embodiment, command line editor module 34 may comprise logic and information stored in order to determine execution of a command 26 by the selected network device 50.

In at least one other embodiment, command line editor module 34 performs a consistency check on network 60 and/or network device 50. The consistency check determines whether network 60 and/or network device 50 are functioning properly, e.g., as expected. In at least one embodiment, the consistency check determines whether a response is received and/or whether the response corresponds to one of a set of possible responses expected by the command line editor module 34 in response to the transmitted command 26. Command line editor module 34 may either directly perform the consistency check or the command line editor module may utilize another set of executable instructions, e.g., another module, to perform the consistency check.

In at least one other embodiment, command line editor module 34 applies configuration script rules 36 to command script 24, e.g., by reading and transmitting the next sequential command 26 in the list of commands identified in the command script 24. In other embodiments, configuration script rules 36 used by command line editor module 34 may cause the command line editor module to interpret a more complex script language such as a “C shell” scripting format from UNIX. Command line editor 34 may also tailor a command for a particular network device 50. For example, configuration script rules 36 may comprise information specifying that a command to set the date on a particular network device 50 is changed for the specific format for the particular network device, e.g., the command may be “set date january 1, 2006” and the network device may require the format to be “date set 1/1/2006”. Command line editor module 34 applies rules specified in configuration script rules 36 to reformat the command “set date january 1, 2006” to “date set 1/1/2006” in order that particular network device 50 accepts the command.

In at least one embodiment, command line editor module 34 transmits commands 26 to a single network device 50. In at least some embodiments, command line editor module 34 transmits commands 26 to a user-selected list of one or more of network devices 50. The user-selected list of network devices is stored in the selected network device list 28 in data store 22. Command line editor module 34 causes the display of a graphical user interface or a text based interface, or any other type of interface in order to enable the selection of a list of network devices 50 by user 44. User 44 may enter an identifier of the selected network device 50 or select the network device from a list displayed by the command line editor module 34 via output device 40. In at least some embodiments, other sets of executable instructions, e.g., software and/or hardware, such as debugging modules, or network performance modules adapted to communicate with the command line editor module 34, may generate the selected network device list 28 and the list of network devices 50.

In at least one other embodiment, selected network device list 28 is a textual list stored in data store 22. In at least some embodiments, selected network device list 28 is stored remotely on another computing device and/or data store.

Commands 26 are text to be transmitted to one of network devices 50 for execution by the network device. In at least one embodiment, commands 26 may be objects, e.g., pointers to executable code for network device 50 to execute or pointers to other modules for execution by the network device. In at least some other embodiments, commands 26 may be a signal indicative of a requested command to be executed by the network device.

In FIG. 1, user 44 is illustrated as a person. In at least some other embodiments, user 44 may be a computing device and/or executable software for analyzing and responding to output and input from command line editor module 34. User 44 may reside in the same computing device 20 as command line editor module 34 in which case input device 38 and output device 40 functionality is realized through intra computing device 20 communications. User 44 may further comprise algorithms, decision-making routines, etc., for analyzing and responding to output from and providing commands and information to command line editor 34. User 44 may be an expert system for configuring network devices 50.

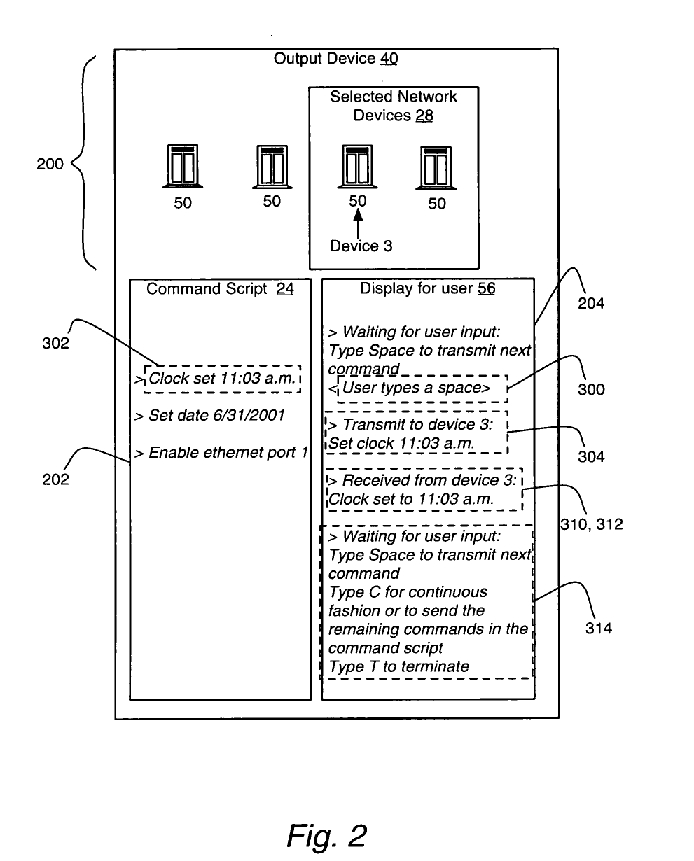

FIG. 2 illustrates an example user interface according to at least one embodiment. FIG. 2 comprises three regions: a device region 200, a script region 202, and a user region 204. Device region 200 depicts the network devices 50 selectable by the user 44. In at least one embodiment, device region 200 may be populated by information received from one or more additional modules. Selected network device list 28 is indicated by a box surrounding two of four devices in device region 200. One of the selected network devices 50 is labeled “device 3”, which is the network device 50 with which command line editor module 34 is currently in communication. Script region 202 comprises a textual listing of commands 26 of command script 24 transmitted to the selected network device 50, i.e., “device 3”. Command script 24 comprises three commands: “Clock set 11:53 a.m.”, “Set date 6/31/2001”, and “Enable Ethernet port 1”. User region 204 displays commands and information input to and output received from command line editor module 34.

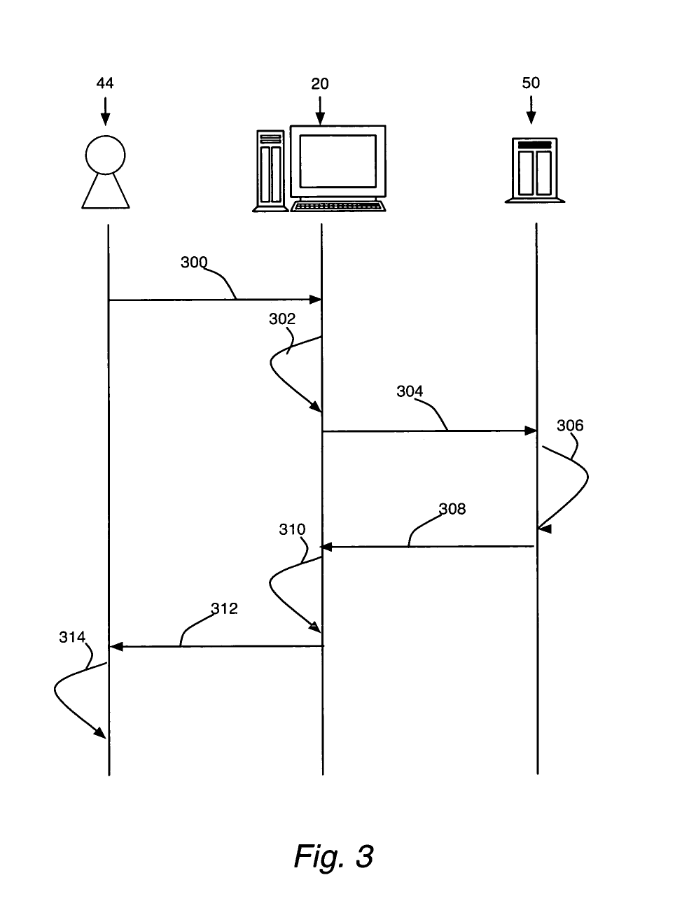

FIG. 3 is a message flow diagram according to an embodiment. As illustrated, user 44 transmits a command, e.g., by typing a space, to command line editor module 34 instructing the command line editor module to transmit a command 26 of the command script 24 to the selected one of network devices 50, here “device 3” (Event 300). Command line editor module 34 applies configuration script rules 36 to command script 24 to determine the command 26 to be transmitted to the selected one of network devices 50. Configuration script rules 36 specify that the command 26 to be transmitted is the next sequential command in command script 24, i.e., “Clock set 11:03 a.m.” (Event 302). Command line editor module 34 transmits the command 26, “Clock set 11:03 a.m.”, to the selected one of network devices 50 over network 60 (Event 304). Network device 50 receives transmitted command 26 and executes the command (Event 306). Network device 50 then transmits a completion response indicative of the results of executing the received command 26 to computing device 20 (Event 308). Command line editor module 34 receives the transmitted completion response from the selected one of network device 50 and determines that the device completed execution of the transmitted command, “Clock set 11:03 a.m.”, and causes the display of the received response in user region 204 of output device 40 (Events 310 and 312). After display of the received completion response, command line editor module 34 causes output device 40 to display in user region 204 a request for user 44 to enter a command (Event 314). As illustrated in FIG. 2, user 44 may command the command line editor module 34 to: send the next command 26 from command script 24, i.e., “Set date 6/31/2001”, and proceed in a step-wise fashion through the command script; send the remaining commands in the command script, i.e., “Set date 6/31/2001” and “Enable Ethernet port 1”, and proceed in a continuous fashion to cause command line editor module 34 to transmit the remaining commands; or terminate the command script execution.

In at least one embodiment, the user interface displayed on output device 40 may comprise one or more buttons corresponding to user commands for input to command line editor module 34.

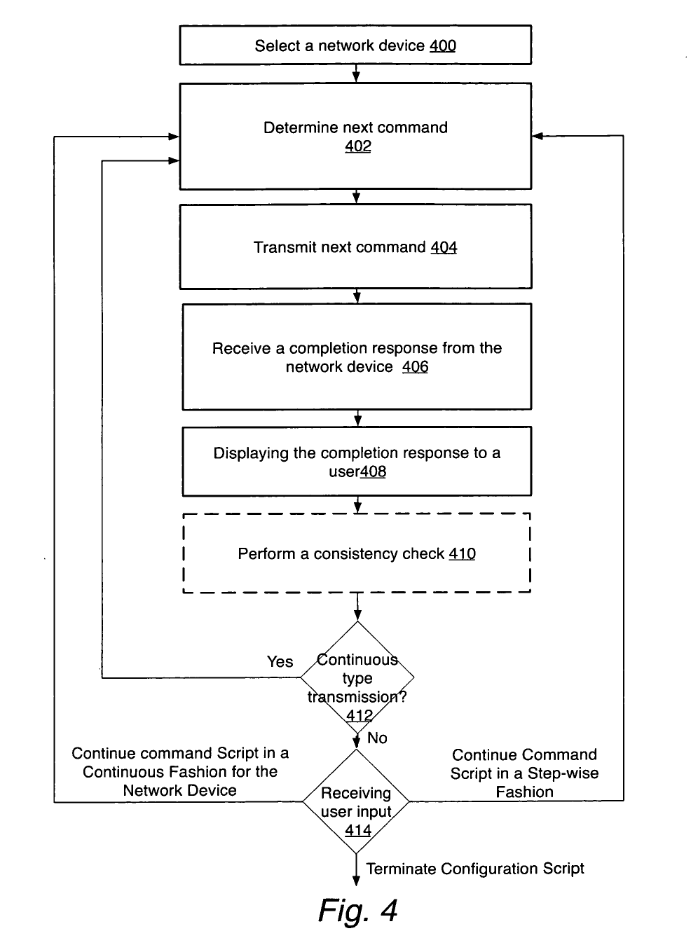

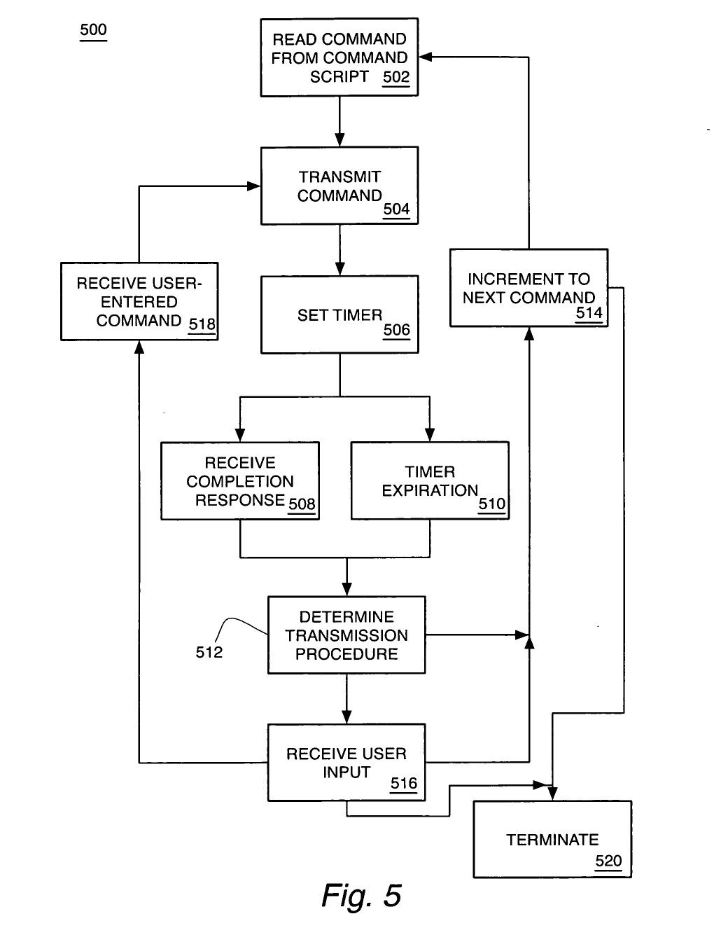

FIG. 4 is a process flow diagram of an embodiment. As illustrated in FIG. 4, a method for providing a step-wise command line interface for configuring a network device 50 comprises selecting a network device to which commands are to be transmitted for execution (Block 400). For example, as illustrated in FIG. 2 network devices 50 may be displayed as icons on output device 40 and selected with input device 38. Network devices 50 may be selected by user 44 identifying the network devices by entering device identifiers of the network devices 50. Network devices 50 may also be selected by another module, e.g., executable software and/or a computing device. For example, a network monitor application having identified a particular network device 50 as defective may then initiate command line editor module 34 with the determined defective network device 50 already selected. In at least one embodiment, more than one of the network devices 50 may be selected by user 44 using input device 38.

The flow of control proceeds to cause processor 30 executing command line editor module 34 to determine a next command 26 from command script 24 by applying configuration script rules 36 to the command script (Block 402). For example, command line editor module 34 may read the next sequential command 26 from command script 24. In at least one embodiment, a default set of configuration script rules 36 may be applied in which a sequential reading of commands 26 from command script 24 is performed.

In at least some embodiments, command line editor module 34 may receive a user-entered command 26 for transmission to the selected network device, e.g., the module may check to see if the user has entered a command using input device 38 and, if a command was entered, transmit the user-entered command as the next command 26 to the selected network device. In at least one embodiment, configuration script rules 36 may enable command script 24 to be a general purpose computer language such as BASIC, or a script language such as “C shell,” “Korn shell,” Python, etc.

The flow of control proceeds to cause processor 30 to transmit the next command 26 to the selected network device 50 over the network 60 (Block 404). In at least one embodiment, command line editor 34 may transmit the next command 26 over network 60 or directly to the selected network device 50 if computing device 20 is directly attached to or a part of the network device.

Processor 30 executing command line editor module 34 instructions receives a completion response from network device 50 (Block 406). The completion response is indicative of the results of the selected network device 50 executing the transmitted command 26. Command line editor module 34 determines whether the network device has completed executing the transmitted command 26. In at least some embodiments, command line editor module 34 waits for the selected network device 50 to transmit a response. In at least some other embodiments, command line editor module 34 may set a timer and await a response from the selected network device. If the timer expires prior to receipt of the response, command line editor module 34 determines that the network device 50 is unable to execute the transmitted command. In at least some embodiments, command line editor module 34 may interpret a received completion response in order to recognize that the selected network device 50 completed executing the transmitted command 26.

Processor 30 executing command line editor module 34 instructions displays the completion response received from the network device 50 to a user 44 via output device 40 (Block 408). In at least one embodiment, command line editor module 34 causes the display of the text of the completion response received from network device 50 on output device 40, so user 44 may view the text of the completion response. In at least some embodiments, command line editor module 34 may display or otherwise communicate the completion response to user 44, e.g., via a graphical, tactile, and/or auditory signals. For example, the completion response may indicate that the network device 50 is working properly and such information may be presented to the user 44 by, for example, turning an icon for the network device 50 green. As another example, the completion response may indicate that the network device 50 is at 20% capacity and may communicate the capacity to user 44 by an animation communicating that the network device is at 20% capacity.

The flow of control continues and processor 30 executing command line editor module 34 instructions performs a consistency check on network 60 and/or network device 50 and displays the consistency check result to user 44 (Block 410). Command line editor module 34 performs an operation to insure network device 50 and/or network 60 is working properly. For example, if network device 50 is a router, command line editor module 34 may route a packet through the router and back to the command line editor module to insure that the router is working. In at least one embodiment, command line editor module 34 performs the consistency check after receiving the completion response so that user 44 may insure the working status of network 60 and/or network device 50.

The flow of control continues and processor 30 executing command line editor module 34 instructions determines if the current mode of the module is a continuous fashion (Block 412). If user 44 has selected for the command script 24 to be executed in a continuous fashion, then the flow of control returns to determine the next command (per Block 402).

The flow of control continues and processor 30 executes command line editor module 34 and receives a user-entered command and/or information (Block 414). In at least one embodiment, command line editor module 34, responsive to received user input, proceeds in a step-wise fashion by repeating Block 402 through Block 414, i.e., the command line editor module 34 flow of control returns to determine the next command to be transmitted to network device 50. Command line editor module 34 may proceed in a continuous fashion by returning to determine the next command, Block 402, and not receiving further user input before processing the remainder of commands 26 from command script 24. Command line editor 34 may terminate based on a received user-entered command and/or information. In at least some embodiments, command line editor 34 receives a next command from user 44 and transmits the next command 26 to the selected network device 50.

In at least some embodiments, command line editor module 34 permits user 44 to select a list of network devices 50 and transmits commands 26 from command script 24 to the network devices 50 in the selected network device list. In at least some embodiments, command line editor module 34 may allow the user 44 to specify a breakpoint command 26. Command line editor module 34 switches from continuous fashion to step-wise fashion for transmission of commands from command script 24 upon encountering a next command 26 which was a breakpoint.

FIG. 5 depicts a process flow 500 of command line editor module 34 according to another embodiment. Given a user-selected network device 50 to which commands 26 from command script 24 are to be transmitted, the flow of control begins with command line editor module 34 reading a command 26 from command script 24 (read command function 502). The flow proceeds to transmit command function 504 and command line editor module 34 causes computing device 20 to transmit the read command to the user-selected network device 50 using network interface 42 and network 60.

The flow of control proceeds to set timer function 506 and command line editor module 34 sets a timer value indicating a time period within which a completion response from the user-selected network device 50 is expected to be received. Setting of the timer value starts a countdown timer. In at least one embodiment, the timer value may be specified as either part of command script 24, configuration script rules 36, or as a data entry in data store 22.

Responsive to receipt of a completion response (receive completion response function 508) from user-selected network device 50, the flow of control proceeds to determine transmission procedure function 512. Responsive to expiration of the countdown timer (timer expiration function 510) prior to receipt of a completion response, the flow of control proceeds to determine transmission procedure function 512.

Command line editor module 34 determines (determine transmission function 512) whether a continuous mode of command transmission is to be used or a step-wise mode of command transmission is to be used for user-selected network device 50. In at least one embodiment, the command transmission mode is specified either by user 44, as part of command script 24, as part of selected network device list 28, as part of configuration script rules 36, or stored separately within data store 22. If the determination is that a step-wise mode is to be used, the flow of control proceeds to receive user input function 516. If the determination is that a continuous mode is to be used, the flow of control proceeds to increment function 514.

Execution of receive user input function 516 causes output device 40 to display a request for user input, e.g., similar to the prompt at 314 of FIG. 2. If user 44 indicates continuation of the flow to cause transmission of the next command 26 from command script 24, the flow of control proceeds to increment function 514. Increment function 514 causes command line editor module 34 to obtain the next command 26 from command script 24 and the flow proceeds to read command function 502. If increment function 514 reaches the end of command script 24, i.e., there are no more commands 26 remaining, the flow of control proceeds to terminate function 520 and the process completes for the user-selected network device 50.

If user 44 indicates continuation of the flow without further stops at receive user input function 516, command line editor module 34 stores the user indication to be read by determine transmission function 512. In at least one embodiment, the command transmission mode is specified either by user 44, as part of command script 24, as part of selected network device list 28, as part of configuration script rules 36, or stored separately within data store 22. The flow of control proceeds to increment function 514.

If user 44 indicates a particular command 26 for transmission, e.g., by entering a user-input command in user region 204 (FIG. 2), the flow of control proceeds to receive user command function 518. Receive user command function 518 receives the user-entered command and the flow proceeds to transmit command function 504. In at least one embodiment, command line editor module applies configuration script rules 36 to the user-entered command at receive user command function 518.

If user 44 indicates termination of the process at receive user input function 516, the process flow proceeds to terminate function 520.

In at least one embodiment, user 44 is able to cause execution of process 500 for one or more additional network devices in selected network device list 28.

In this manner, a user may cause step-wise transmission of commands from a command script to a network device. The user is thus able to verify the operation of the commands and the command script with respect to the network device prior to causing transmission of the commands in a continuous mode to one or more additional network devices.

Beneficially, the user is able to execute a script containing commands for network devices one command at a time and is able to examine the response from the network device as a result of the device executing the command before taking further action with respect to one or more additional network devices. This functionality permits the user to ensure the command script is working properly for each command in the script for the network device prior to committing to transmitting the script commands to one or more additional network devices. The user can thus debug and gain confidence in the proper functioning of the script by being able to examine the response to each command. After gaining confidence that the script properly functions on the selected network device(s), the user can direct the system to transmit the commands of the script in a continuous fashion where the remaining commands are transmitted to the network device without waiting for a further user-entered command and/or information and/or a response from the network device.

What is claimed is:

1. A system for configuring a network device, comprising:
a computing device comprising a data store and a network interface; and,
a command line editor module resident in the data store and adapted to transmit commands in a step-wise mode from a command script to a selected network device, wherein the step-wise mode transmits a selected command from the command script to the network device then waits for the network device to complete execution of the transmitted command and then displays to the user a completion response received from the selected network device, and then waits for input from a user before transmitting a next selected command from the command script to the selected network device, wherein the completion response is indicative of the results of executing the transmitted command on the selected network device.

2. The system of claim 1, wherein the command line editor module is further adapted to perform a consistency check after waiting for the selected network device to complete execution of the transmitted command, wherein the consistency check is indicative of the functioning of the selected network device and/or the network.

3. The system of claim 1, wherein the input from a user is selected from terminate command script; continue command script in a step-wise mode; and, continue command script in a continuous mode, wherein continuous mode transmits the remaining commands from the command script to the selected network device without no waiting for either user input or for the selected network device to complete execution of transmitted commands.

4. The system of claim 3, wherein the command line editor module is further adapted to enable the user to designate a selected command from the command script as a breakpoint command, wherein when the next command is a breakpoint command the command line editor module continues in a step-wise mode.

5. The system of claim 3, wherein the command line editor module is further adapted to permit the user to select a list of network devices and apply the command script to the list of network devices.

6. The system of claim 1, wherein the command line editor module is further adapted to translate the commands for network devices from a command script language to configuration commands tailored for the selected network device.

7. A method of configuring network devices over a network, comprising:
(a) selecting a network device;
(b) determining a next command from a command script, wherein the next command is determined by applying configuration script rules to the command script;
(c) transmitting the next command to the selected network device over a network;
(d) receiving a completion response from the network device over a network, wherein the completion response is indicative of the results of executing the transmitted command on the selected network device;
(e) displaying the completion response to a user;
(f) receiving user input based on the displayed completion response; and
(g) responsive to user input received, performing an action comprising at least one of: 1) proceeding in step-wise mode by repeating steps (b)-(g); 2) terminating execution of the configuration script; and 3) proceeding in a continuous mode by repeating steps (b)-(e) for each remaining command in the configuration script.

8. The method of claim 7, further comprising the steps between steps (e) and (f): of performing a consistency check and displaying the results of the consistency check to the user, wherein the consistency check is indicative of the functioning of the selected network device and/or the network.

9. The method of claim 7, further comprising the step before step (a) of allowing the user to select a list of network devices, and then applying steps (a)-(g) to the list of network devices.

10. The method of claim 7, further comprising the step between steps (b) and (c) of translating the next command from a command script language to configuration commands tailored for the selected network device.

11. The method of claim 7, further comprising the step between steps (a) and step (b) of enabling the user to designate a selected command from the command script as a breakpoint command, and further comprising the step between steps (b) and (c) of switching from continuous mode to step-wise mode when the next command is a breakpoint command.

12. A memory or a computer-readable medium storing instructions that, when executed by a processor, cause the processor to select a network device, determine a next command from a command script, transmit the next command to the selected network device, receive a completion response from the network device, display the completion response, responsive to user input perform an action comprising proceeding in a step-wise manner to transmit a next command to the selected network device.
